(19) United States
(12) Patent Application Publication
(10) Pub. No.: US 2001/0017701 A1
(43) Pub. Date: Aug. 30, 2001

(54) Peripheral device for information processing and information processing system

(76) Inventors: Takafumi Ito, Ome-shi (JP); Shinichi Hiroki, Kawaguchi-shi (JP); Takeshi Ishiguro, Tokyo (JP)

Correspondence Address: Finnegan, Henderson, Farabow, Garrett & Dunner, L.L.P., 1300 I Street, N.W., Washington, DC, 20005-3315, US

(21) Appl. No.: 09/748,855

(22) Filed: Dec. 28, 2000

(30) Foreign Application Priority Data
Jan. 5, 2000 (JP) 2000-000484

(51) Int. Cl. G06F 13/38; G06F 13/12; B41J 1/00; G06K 1/00; B41B 1/00

(52) U.S. Cl. 358/1.1; 710/74

(57) ABSTRACT

A peripheral device for information processing performs cable communication with an information processing apparatus to access a card-type data storage medium. The storage medium is inserted in a slot of the peripheral device. A label on which printing can be performed is stuck on the outer surface of the storage medium. The peripheral device has a printing section for performing printing on the label on the storage medium. The printing section prints the contents of access to the storage medium on the label on the storage medium by using a thermal head while the storage medium is inserted in the slot.

### CROSS-REFERENCE TO RELATED APPLICATIONS

This application is based upon and claims the benefit of priority from the prior Japanese Patent Application No. 2000-000484, filed Jan. 5, 2000, the entire contents of which are incorporated herein by reference.

### BACKGROUND OF THE INVENTION

The present invention relates to a peripheral device for information processing and an information processing system, for accessing a card-type data storage medium, which are applied to an information processing apparatus such as a personal computer.

In general, in an information processing apparatus such as a personal computer (PC), access to a storage medium such as a memory card is made through a peripheral device (card drive). The peripheral device accesses the storage medium put therein under the control from the PC side, thereby, for example, storing, deleting, or reading data.

The contents stored in the card-type medium, i.e., file names, the stored data capacity, and the remaining storage capacity can be checked by accessing the card-type medium from the PC through the peripheral device. Alternatively, the file names of data stored in the card-type medium and the like may be recorded on a card label in advance, and the card label may be stuck on the card-type medium in advance. This allows the user to check the contents stored in the card-type medium without performing any accessing operation from the PC. File names and the like are recorded on a card label as follows. The user checks the contents stored in the card-type medium by accessing it from the PC. The contents are then printed on the label by using another device such as a label printer or handwritten on the label.

As described above, according to the prior art, the contents of files stored in the card-type medium, the stored data capacity, the remaining storage capacity, and the like are checked by performing operation from a PC serving as a host unit or printing the contents stored in the card-type medium on a card level in advance and sticking the label on the card-type medium in advance. That is, according to the conventional peripheral device, when the contents recorded on the card-type medium need to be checked, the user must operate the PC. In addition, even if a card label is to be used, the user must operate the PC. Furthermore, since the user must print data on the card label, the operation load on the user is heavy. When data is to be printed on the card label, a label printer must be prepared in addition to a PC.

### BRIEF SUMMARY OF THE INVENTION

It is an object of the present invention to provide a peripheral device for information processing and information processing system which allow a user to easily check the contents recorded on card-type media without increasing the operation load on the user.

According to a first aspect of the present invention, there is provided an information processing system for accessing a data storage medium having a card shape, the storage medium having an outer surface on which printing can be performed, comprising:

a data processing section;

a supporting section configured to support the storage medium;

a connecting section configured to interface the data processing section with the storage medium, when the storage medium is supported by the supporting section; and

a printing section configured to perform printing on the outer surface of the storage medium, when the storage medium is supported by the supporting section, the printing section printing, on the outer surface of the storage medium, contents of access to the storage medium which is made by the data processing section to store, delete, or read data with respect to the storage medium through the connecting section.

According to a second aspect of the present invention, there is provided a peripheral device for information processing configured to communicate with an information processing apparatus and to access a data storage medium having a card shape, the storage medium having an outer surface on which printing can be performed, comprising:

a data processing section;

a supporting section configured to support the storage medium;

a first connecting section configured to interface the data processing section with the information processing apparatus;

a second connecting section configured to interface the data processing section with the storage medium, when the storage medium is supported by the supporting section; and

a printing section configured to perform printing on the outer surface of the storage medium, when the storage medium is supported by the supporting section, the printing section printing, on the outer surface of the storage medium, contents of access to the storage medium which is made by the data processing section to store, delete, or read data with respect to the storage medium through the second connecting section.

According to a third aspect of the present invention, there is provided a peripheral device for information processing configured to communicate with an information processing apparatus and to access a data storage medium having a card shape, the storage medium having an outer surface on which printing can be performed, comprising:

an accessing section configure to access the storage medium; and

a printing section configured to perform printing on the outer surface of the storage medium, wherein the printing section prints, on the outer surface of the storage medium, contents of access to the storage medium which is made by the accessing section to store, delete, or read data with respect to the storage medium.

With the arrangement described above, access to a medium and print on a label can be performed concurrently with each other, thereby reducing operation load on a user, and allowing the user to easily use the device or the system.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the system configuration of a card drive serving as a peripheral device for information processing according to an embodiment of the present invention;

FIG. 2 is a block diagram showing the arrangement of an information processing system using the card drive;

FIG. 3 is a plan view showing the positional relationship between a thermal head and an SD card serving as a card-type data storage medium in the card drive while the SD card is connected to an SD card connector;

FIG. 4 is a side view showing the positional relationship between the thermal head and the SD card while the SD card is connected to the SD card connector;

FIG. 5 is a flow chart for explaining operation of automatic printing of contents stored in the SD card, in which printing (or erasure) on a card label is performed concurrently with access to the SD card in the first embodiment;

FIG. 6 is a view for explaining the contents stored in a printed content storage file;

FIG. 7 is a view showing an example of contents printed on the card label in the first embodiment;

FIG. 8 is a flow chart for explaining operation of automatic printing of contents stored in the SD card, in which printing (or erasure) on a card label is performed concurrently with access to the SD card in the second embodiment; and

FIG. 9 is a view showing an example of contents printed on the card label in the second embodiment.

### DETAILED DESCRIPTION OF THE INVENTION

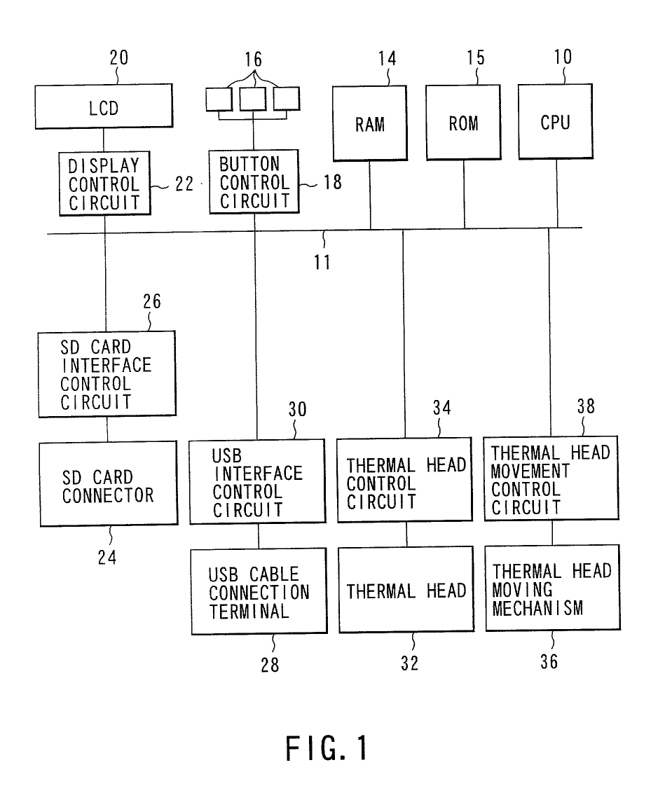

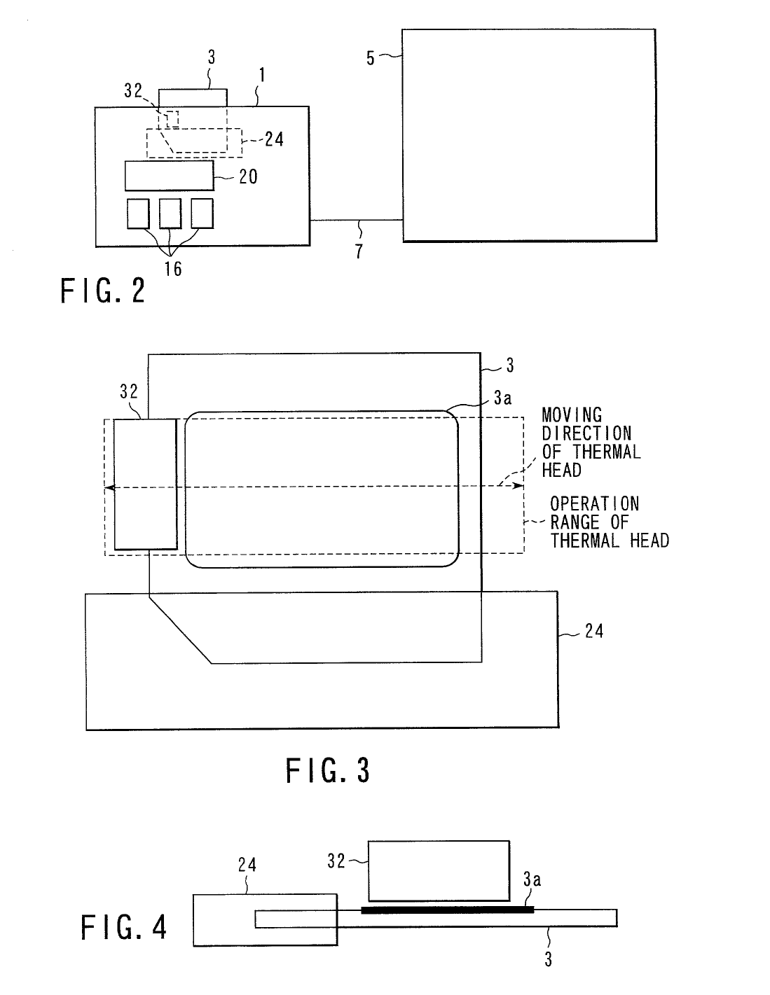

Embodiments of the present invention will be described below with reference to the views of the accompanying drawing. FIG. 1 is a block diagram showing the system configuration of a card drive 1 serving as a peripheral device for information processing according to an embodiment. FIG. 2 is a block diagram showing the arrangement of an information processing system using the card drive 1.

As shown in FIG. 1, the card drive 1 of this embodiment includes a CPU 10, internal bus 11, ROM 12, RAM 14, operation buttons 16, button control circuit 18, LCD 20, display control circuit 22, SD card connector 24, interface control circuit 26, USB cable connection terminal 28, USB interface control circuit 30, thermal head 32, thermal head control circuit 34, thermal head moving mechanism 36, and thermal head movement control circuit 38.

As shown in FIG. 2, the card drive 1 is configured to access, for example, an SD (Secure Digital) card 3 serving as a card-type data storage medium. The card drive 1 can execute operation as that of a label printer as well as basic operation of driving the SD card 3 in accordance with information sent from a personal computer (PC) 5 serving as a host unit through a USB (Universal Serial Bus) cable 7.

The CPU 10 controls the entire card drive 1, and executes, for example, the following processing on the basis of information received from the PC 5 through the USB cable connection terminal 28 and USB interface control circuit 30. The CPU 10 accesses the SD card 3 connected to the SD card connector 24 under the control of the SD card interface control circuit 26. The CPU 10 also performs printing on a card label stuck on the SD card 3 under the control of the thermal head control circuit 34 and thermal head movement control circuit 38.

The ROM 12 is a reading only memory for the CPU 10, which stores programs and/or data. In this embodiment, an access control program for controlling access to the SD card 3, a print control program for controlling printing on a card label stuck on the SD card 3, and the like are stored in the ROM 12. The RAM 14 is a read/write memory for the CPU 10, and is used as a working area for temporarily storing various kinds of data.

The operation buttons 16 are used for inputting various kinds of instructions from a user to the card drive 1. The movement and/or operation content of the operation buttons 16 are detected by the button control circuit 18 and reported to the CPU 10. The LCD 20 is provided to display the operation state of the card drive 1, notifications to a user, and so forth, and is controlled by the display control circuit 2.

The SD card connector 24 serves to connect the SD card 3 serving as a card-type data recording medium. When the SD card 3 is inserted in a slot in the casing of the card drive 1, the SD card 3 is connected to the SD card connector 24. The interface control circuit 26 accesses the SD card 3 connected to the SD card connector 24 under the control of the CPU 10, thereby storing, deleting, or reading data.

The USB cable connection terminal 28 is a connector for connecting the SD card 3 to the PC 5 through a cable (USB cable 7). The USB interface control circuit 30 controls communication with the PC 5 through the USB cable 7 connected to the USB cable connection terminal 28. With this operation, the USB interface control circuit 30, for example, accesses the SD card 3 and receives information for printing on a card label.

The thermal head 32 performs printing on a card label stuck on a surface portion of the SD card 3 which is connected to the SD card connector 24 to become an access target. In this embodiment, special thermal paper is used for a card label stuck on the SD card 3, and heat of a predetermined temperature is added to the thermal head 32, thereby performing color development (printing). By applying heat of another predetermined temperature to the thermal head 32, the developed color can be erased.

The thermal head control circuit 34 performs control to heat the thermal head 32 to a predetermined temperature at a predetermined timing under the control of the CPU 10, thereby executing printing (or erasure) for the card label on the SD card 3. The thermal head moving mechanism 36 slides the thermal head 32 in a predetermined direction under the control of the thermal head movement control circuit 38. By moving the thermal head 32 to a predetermined position using the thermal head moving mechanism 36, printing (or erasure) is performed for the card label on the SD card 3 connected to the SD card connector 24. The thermal head movement control circuit 38 controls the operation of the thermal head moving mechanism 36 under the control of the CPU 10, thus performing control to slide the thermal head 32 in a predetermined direction.

As shown in FIG. 2, in addition to the operation buttons 16 to be operated by the user and the LCD 20, for example, a USB connector for connection to the PC 5 through the USB cable 7 is provided outside the casing of the card drive 1. A slot through which the SD card 3 is loaded is formed in the casing of the card drive 1. By inserting the SD card 3 into the slot, the SD card 3 is connected to the SD card connector 24 provided in the casing. The thermal head 32 is placed to coincide with the position of the card label stuck on the SD card 3 while the SD card 3 is connected to the SD card connector 24.

FIGS. 3 and 4 show the positional relationship between the SD card 3 and the thermal head 32 while the SD card 3 is connected to the SD card connector 24.

As shown in FIGS. 3 and 4, the thermal head 32 is placed such that a card label 3a stuck on the surface portion of the SD card 3 coincides with the moving range of the thermal head 32. As shown in FIGS. 3 and 4, the thermal head moving mechanism 36 (see FIG. 1) slides the thermal head 32 in the directions indicated by the arrows in FIG. 3, which are perpendicular to the direction in which the SD card 3 is connected to the SD card connector 24. The thermal head 32 is pressed against the card label 3a at a predetermined timing while being moved on the surface of the SD card 3 by the thermal head moving mechanism 36, thereby executing printing or erasure for the card label 3a (special thermal paper).

The operation of the card drive 1 (peripheral device) according to the first embodiment of the present invention will be described next.

[1] Operation as Card Drive:

An SD card 3 is loaded into the card drive 1 so as to be connected to the SD card connector 24. The card drive 1 receives access information and write information for the SD card 3 from the PC 5 through the USB cable 7, USB cable connection terminal 28, and USB interface control circuit 30. Upon reception of access information for requesting data storage for the SD card 3 from the PC 5, the CPU 10 of the card drive 1 transmits the access information to the SD card 3 through the interface control circuit 26. The SD card 3 stores in the internal memory the data received from the PC 5 through the card drive 1.

Upon reception of access information for requesting a read of data stored in the SD card 3 from the PC 5, the CPU 10 of the card drive 1 reads out corresponding data from the SD card 3 and sends it to the PC 5 through the USB cable 7.

[2] Operation as Label Printer:

The card drive 1 operates as a thermal label printer as well as a card drive like the one described above.

When the card drive 1 receives write information for instructing printing/erasing operation from the PC 5 through the USB cable 7, the CPU 10 controls the thermal head control circuit 34 and thermal head movement control circuit 38 to execute printing/erasing operation for the card label 3a of the SD card 3. With this operation, the user can arbitrarily perform label printing on the card label 3a stuck on the SD card 3 by operating the PC 5 as well as accessing the SD card 3 in the card drive 1.

[3] Automatic Printing of Contents Stored in SD Card 3:

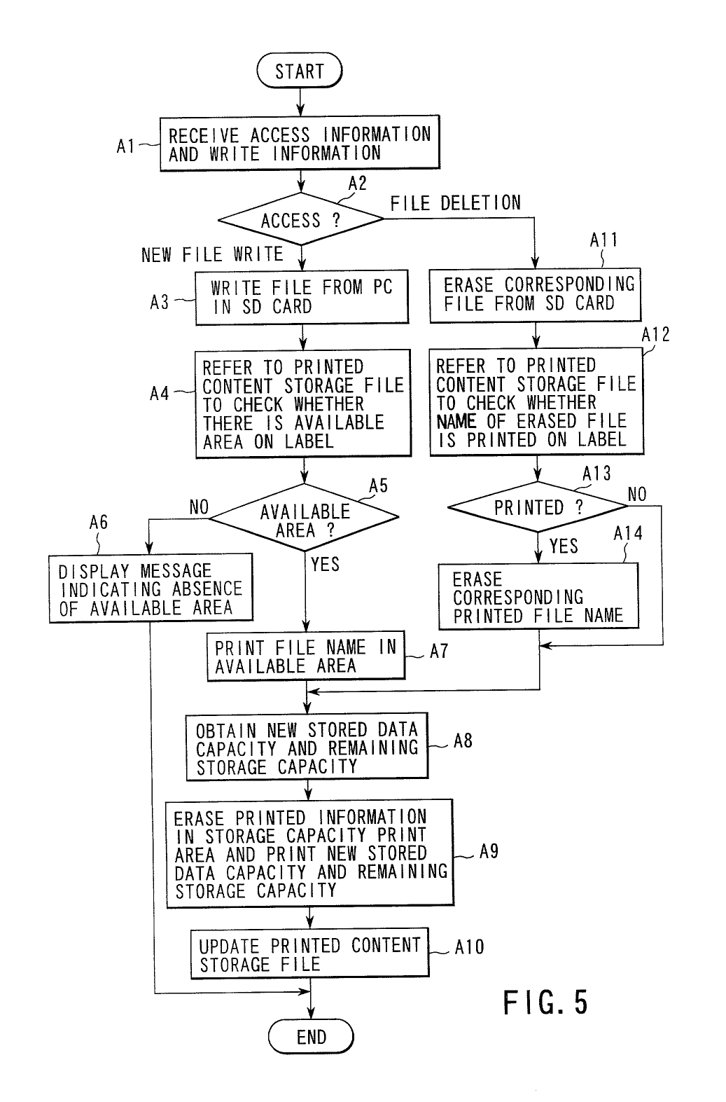

Operation of automatic printing of contents stored in the SD card 3, in which printing (or erasure) on the card label 3a is performed concurrently with access to the SD card 3, will be described next with reference to the flow chart of FIG. 5. Settings are made in advance such that stored contents are automatically printed by operating the operation buttons 16 in accordance with access from the PC 5.

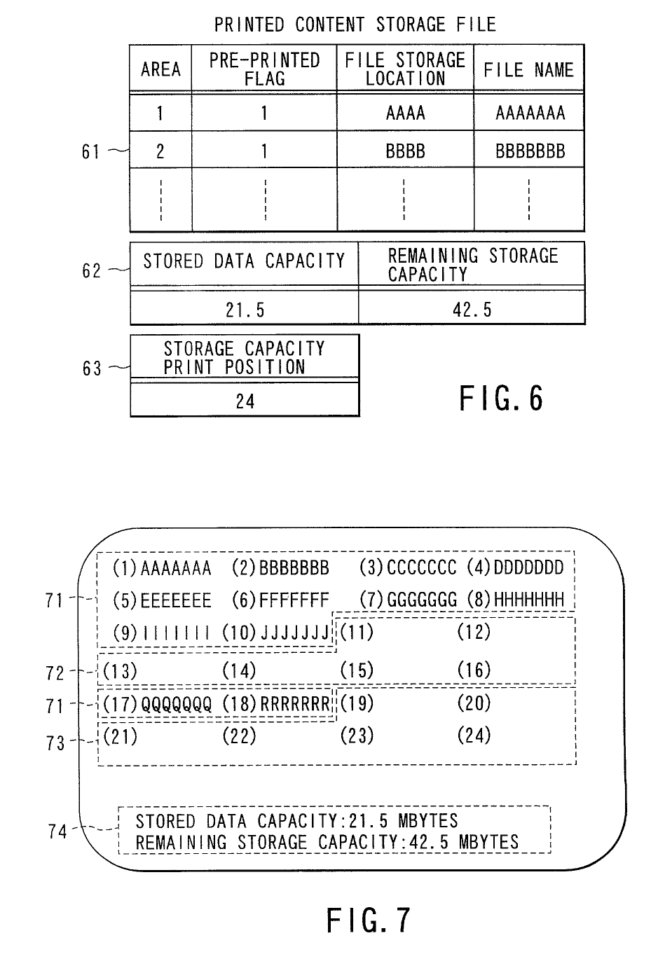

To automatically print the contents stored in the SD card 3, the card drive 1 causes the SD card 3 to store a dedicated file for automatic printing management (print content storage file). For example, as indicated by reference numeral 61 in FIG. 6, the print content storage file contains the following data for each of areas (1, 2, . . .) on the card label 3a, in which the name of a stored file is printed. Specifically, the data includes a “pre-printed” flag indicating whether a file name has already been printed, the storage location of a file (data) corresponding to the file name printed in the area, and the file name. In addition, as indicated by reference numeral 62 in FIG. 6, the printed content storage file contains the stored data capacity and remaining storage capacity of the entire card drive 1.

In this first embodiment, as shown in FIG. 7, for example, a total of 24 areas (see reference numerals 71 to 73) in which file names can be printed are set on one card label 3a. In addition to areas in which file names are printed, a storage capacity print area in which the contents of the stored data capacity of the SD card 3 are printed (see reference numeral 74) is set on the card label 3a.

<New File Write>

First of all, the card drive 1 receives access information (new file write) and write information (label print execution) for the SD card 3 from the PC 5 through the USB cable 7 (Step A1). If the access from the PC 5 is write access for a new file (Step A2), the CPU 10 writes a file from the PC 5 in the SD card 3 through the interface control circuit 26 and SD card connector 24.

In addition, the PC 5 reads out the printed content storage file stored in the SD card 3. It is checked on the basis of this printed content storage file whether the card label 3a stuck on the SD card 3 has an area in which a file name can be written (Step A4).

If the card label 3a has no available area (Step A5), a message indicating that no available area is present is displayed on the PC 5, and the user is notified that the name of the new file written in the SD card 3 cannot be printed on the card label 3a (Step A6). If the card label 3a has an available area in which the file name can be printed (Step A5), the name of the new file written in the SD card 3 is printed in the next printed target area (Step A7).

The PC 5 obtains a new stored data capacity and remaining storage capacity which are changed upon writing the new file in the SD card 3 (Step A8). In the manner shown in FIG. 7, the contents printed in the storage capacity print area (reference numeral 74) of the card label 3a are erased, and the new stored data capacity and remaining capacity are printed (Step A9).

The PC 5 updates the contents of the printed content storage file and causes the SD card 3 to store them (Step A10). More specifically, the PC 5 additionally registers the name of the newly written file and file storage location in correspondence with the print area in which the file name is written, and sets the “pre-printed” flag as a flag indicating that the file name has already been printed. In addition, the PC 5 updates the new stored data capacity and remaining capacity.

<File Deletion>

If the access from the PC 5 is delete access (Step A2), the CPU 10 erases the corresponding file stored in the SD card 3 through the interface control circuit 26 and SD card connector 24 (Step A11). The CPU 10 then refers to the print content storage file to check whether the name of the erased file is printed on the card label 3a (Step A12). If the file name has been printed, the CPU 10 erases the printed file name (Step A14).

The PC 5 obtains the new stored data capacity and remaining storage capacity which are changed when the file stored in the SD card 3 is deleted (Step A8). As shown in FIG. 7, the PC 5 erases the printed contents in the storage capacity print area (reference numeral 74) on the card label 3a and prints the new stored data capacity and remaining storage capacity (Step A9).

The PC 5 updates the contents of the printed content storage file and stores the resultant data in the SD card 3 (Step A10). That is, the PC 5 erases the name of the deleted file and its storage location in correspondence with the print area from which the file name has been erased.

In the case shown in FIG. 7, the names of stored files are printed in areas (1) to (10), (17), and (18) of the 24 areas in which file names can be printed (see reference numeral 71). In areas (11) to (16), printed file names were erased because the corresponding files were deleted from the SD card 3 (see reference numeral 72). Areas (19) to (24) are unused areas (see reference numeral 73). In the storage capacity print area, the stored data capacity “21.5 Mbytes” and remaining storage capacity “42.5 Mbytes” corresponding to the stored files are recorded (see reference numeral 74).

In this manner, a new file is written in the SD card 3 or a file is deleted therefrom in accordance with a request from the PC 5. In this case, the corresponding file name is printed or deleted on/from the card label 3a stuck on the SD card 3 as an access target, and the corresponding storage data capacity and remaining storage capacity are printed. This allows the user to grasp the contents recorded on the SD card 3 by referring to the card label 3a without performing any special operation.

[4] Printing of New Label:

According to the above description, printing or deleting operation for the card label 3a is executed concurrently with access to the SD card 3. However, a new card label 3a can also be created for the SD card 3 in which files have already been stored.

First of all, the PC 5 requests the card drive 1 to create a new card label 3a for the SD card 3 connected to the SD card connector 24. In response to the request from the PC 5, the CPU 10 accesses the SD card 3 connected to the SD card connector 24 to check the existing files.

The CPU 10 prints the names of the files existing in the SD card 3 in areas set on the card label 3a by controlling the thermal head control circuit 34 and thermal head movement control circuit 38. If no available print area is left, no file name is printed any more. The CPU 10 also prints the stored data capacity and remaining storage capacity in the storage capacity area on the card label 3a.

The CPU 10 creates a printed content storage file having contents like those indicated by reference numerals 61 and 62 in FIG. 6 in accordance with the files that have been stored in the SD card 3 and the result of printing performed in accordance with the respective files, and stores the file in the SD card 3.

In this manner, printing on a new label can also be executed independently. That is, for the SD card 3 that has been used in another card drive, label printing can be easily executed on the new card label 3a when it is used in the card drive 1 of this embodiment.

According to the above description, special thermal paper is used for the card label 3a stuck on the SD card 3. This paper develops color upon reception of heat of a predetermined temperature, and the developed color can be erased by applying heat of another predetermined temperature to the paper. However, card labels made of other materials that allow printing and erasing operations can also be used. For example, a material that can form or erase a character pattern on/from a label by using magnetic force can be used. In this case, a material that can be suitably used for a card label is used for a head that performs printing.

The operation of the second embodiment of the present invention will be described next.

In the first embodiment, printing and erasing operations can be arbitrarily performed for the card label 3a. In the second embodiment, only printing can be performed for a card label 3a, but no erasing operation can be performed. Note that the arrangement of a card drive 1 in the second embodiment is the same as that show in FIGS. 1 to 4 as in the first embodiment, and a detailed description thereof will be omitted.

[1] Operation as Card Drive:

An SD card 3 is loaded into the card drive 1 so as to be connected to the SD card connector 24. The card drive 1 receives access information and write information for the SD card 3 from the PC 5 through the USB cable 7, USB cable connection terminal 28, and USB interface control circuit 30. Upon reception of access information for requesting data storage for the SD card 3 from the PC 5, the CPU 10 of the card drive 1 transmits the access information to the SD card 3 through the interface control circuit 26. The SD card 3 stores in the internal memory the data received from the PC 5 through the card drive 1.

Upon reception of access information for requesting a read of data stored in the SD card 3 from the PC 5, the CPU 10 of the card drive 1 reads out corresponding data from the SD card 3 and sends it to the PC 5 through the USB cable 7.

[2] Operation as Label Printer:

The card drive 1 operates as a thermal label printer as well as a card drive like the one described above.

When the card drive 1 receives write information for instructing printing from the PC 5 through the USB cable 7, the CPU 10 controls a thermal head control circuit 34 and thermal head movement control circuit 38 to execute printing on the card label 3a of the SD card 3. Note that since the card drive 1 in the second embodiment can execute only printing on the card label 3a, if erasing operation in the first embodiment is required, a strike-through is additionally printed on the corresponding printed contents so as to indicate that the contents are erased. With this operation, the user can arbitrarily perform label printing on the card label 3a stuck on the SD card 3 as well as accessing the SD card 3 in the card drive 1 by operating the PC 5.

[3] Automatic Printing of Contents Stored in SD Card 3:

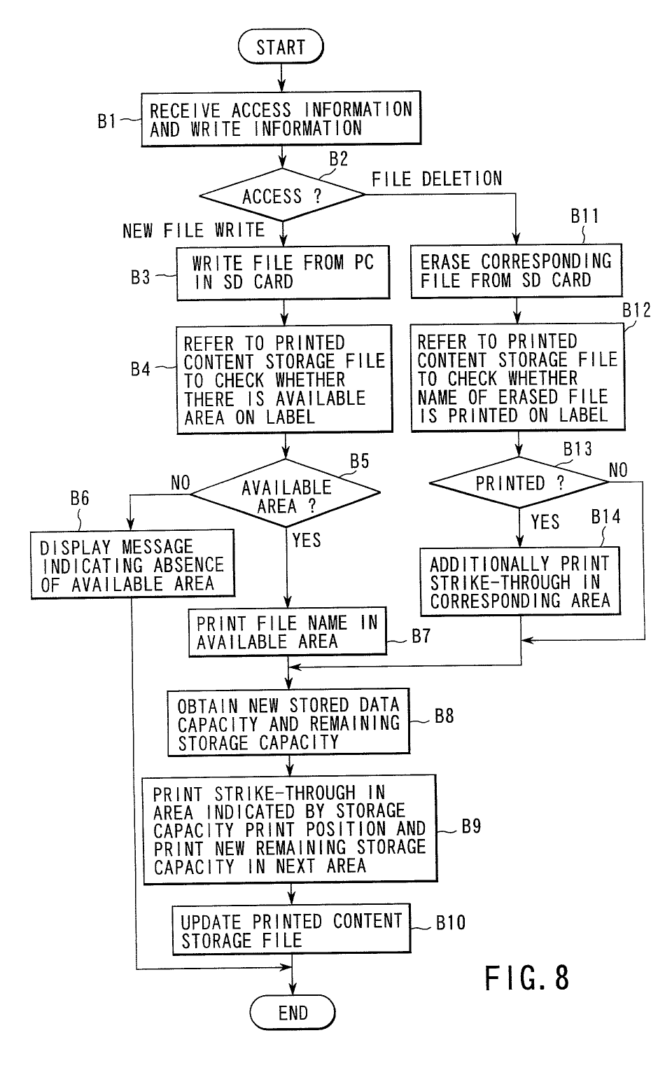

Operation of automatic Printing of contents stored in the SD card 3, in which printing on the card label 3a is performed concurrently with access to the SD card 3, will be described next with reference to the flow chart of FIG. 8. Settings are made in advance such that stored contents are automatically printed by operating operation buttons 16 in accordance with access from the PC 5.

To automatically print the contents stored in the SD card 3, the card drive 1 causes the SD card 3 to store a dedicated file for automatic printing management (print content storage file). For example, as indicated by reference numeral 61 in FIG. 6, the print content storage file contains the following data for each of areas (1, 2, . . .) on the card label 3a, in which the name of a stored file is printed. Specifically, the data includes a “pre-printed” flag indicating whether a file name has already been printed, the storage location of a file (data) corresponding to the file name printed in the area, and the file name. In addition, as indicated by reference numeral 62 in FIG. 6, the printed content storage file contains the stored data capacity and remaining storage capacity of the entire card drive 1. Furthermore, in the second embodiment, as indicted by reference numeral 63 in FIG. 6, the printed content storage file contains a storage capacity print position indicating a position where the remaining storage capacity is printed in the storage capacity print area set on the card label 3a.

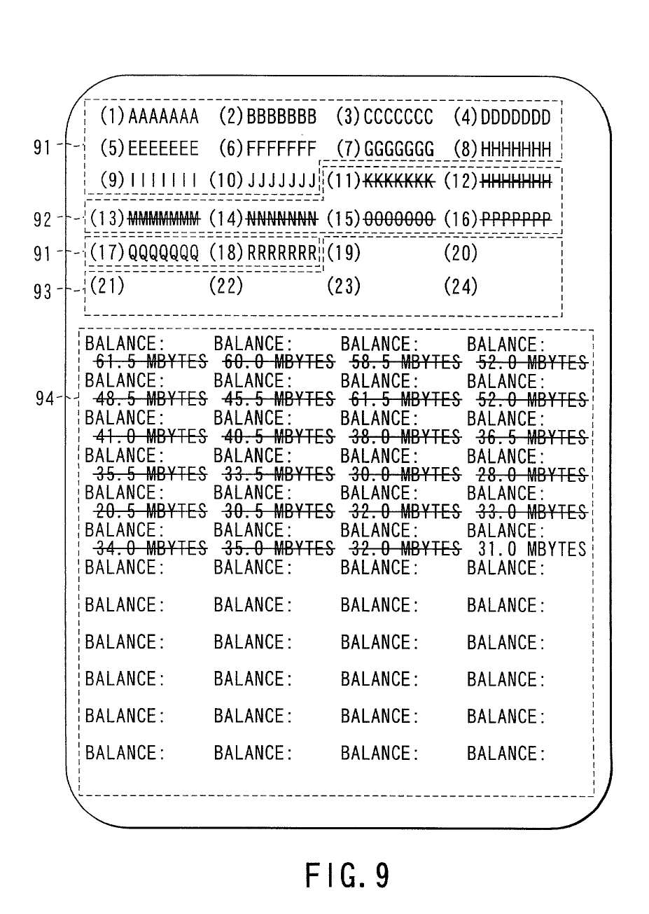

In the second embodiment, as shown in FIG. 9, for example, a total of 24 areas (see reference numerals 91 to 93) in which file names can be printed are set on one card label 3a. In addition to areas in which file names are printed, a storage capacity print area in which the contents of the stored data capacity of the SD card 3 are printed (see reference numeral 94) is set on the card label 3a. In this case, 48 print areas are set in the storage capacity print area. Every time the remaining storage capacity of the SD card 3 changes upon storage or deletion of a file in/from the SD card 3, the print areas are sequentially changed, and the remaining storage capacity is printed. The position of the area in which this remaining storage capacity is to be printed is managed in a printed content storage file (see reference numeral 63 in FIG. 6).

<New File Write>

First of all, the card drive 1 receives access information (new file write) and write information (label print execution) for the SD card 3 from the PC 5 through the USB cable 7 (Step B1). If the access from the PC 5 is write access for a new file (Step B2), the CPU 10 writes a file from the PC 5 in the SD card 3 through the interface control circuit 26 and SD card connector 24.

In addition, the PC 5 reads out the printed content storage file stored in the SD card 3. It is checked on the basis of this printed content storage file whether the card label 3a stuck on the SD card 3 has an area in which a file name can be written (Step B4). In the second embodiment, since the contents printed on the card label 3a cannot be erased, a new area as a print target is set every time a file is stored or deleted.

If the card label 3a has no available area (Step B5), a message indicating that no available area is present is displayed on the PC 5, and the user is notified that the name of the new file written in the SD card 3 cannot be printed on the card label 3a (Step B6). If the card label 3a has an available area in which the file name can be printed (Step B5), the name of the new file written in the SD card 3 is printed in the next printed target area (Step B7).

The PC 5 obtains a new stored data capacity and remaining storage capacity which are changed upon writing the new file in the SD card 3 (Step B8). A strike-through is additionally printed in that area in the storage capacity print area (reference numeral 94) of the card label 3a in FIG. 9 which is indicated by the storage capacity print position (reference numeral 63 in FIG. 6) stored in the printed content storage file, and the new remaining storage capacity is printed in the next area (Step B9). Note that the position indicated by the storage capacity print position (reference numeral 63 in FIG. 6) has an initial value of 0 (position 1 indicating the upper left corner on the first line of the storage capacity print area (reference numeral 94)). This value is sequentially updated every time file storage or deletion is executed.

The PC 5 updates the contents of the printed content storage file and causes the SD card 3 to store them (Step B10). More specifically, the PC 5 additionally registers the name of the newly written file and file storage location in correspondence with the print area in which the file name is written, and sets the “pre-printed” flag as a flag indicating that the file name has already been printed. In addition, the PC 5 updates the new stored data capacity and remaining capacity, and updates the value of the storage capacity print position into a value indicating the area where printing has been performed. In the case shown in FIG. 9, since the remaining capacity is printed in the 24th area in the storage capacity print area, the value of the storage content print position is updated to “24” as indicated by reference numeral 63 in FIG. 6.

<File Deletion>

If the access from the PC 5 is delete access (Step B2), the CPU 10 erases the corresponding file stored in the SD card 3 through the interface control circuit 26 and SD card connector 24 (Step B11). The CPU 10 then refers to the print content storage file to check whether the name of the erased file is printed on the card label 3a (Step B12). If the file name has been printed, the CPU 10 discriminates the area in which the corresponding file name is printed by referring to the printed content storage file, and additionally prints a strike-through in the corresponding area (Step B14).

The PC 5 obtains the new stored data capacity and remaining storage capacity which are changed when the file stored in the SD card 3 is deleted (Step B8). As shown in FIG. 9, the PC 5 additionally prints a strike-through in that area in the storage capacity print area of the card label 3a which is indicated by the storage capacity print position in the stored content storage file, and prints the new remaining storage capacity in the next area (Step B9).

The PC 5 updates the contents of the printed content storage file and stores the resultant data in the SD card 3 (Step B10). That is, the PC 5 erases the name of the deleted file and its storage location in correspondence with the print area from which the file name has been erased. In addition, the PC 5 updates the stored data capacity and remaining storage capacity. The PC 5 also updates the value of the storage capacity print position into a value indicating the area in which printing has been performed.

In the case shown in FIG. 9, the names of stored files are printed in areas (1) to (10), (17), and (18) of the 24 areas in which file names can be printed (see reference numeral 91). In areas (11) to (16), strike-throughs are additionally printed on file names so as to indicate that the files are erased upon deletion of the files from the SD card 3, whose file names have been printed (see reference numeral 92). Areas (19) to (24) are unused areas (see reference numeral 93). In the storage capacity print area, the remaining storage capacity “31.0 Mbytes” is recorded in the 24th area (see reference numeral 94).

In addition to the effects of the card drive 1 in the first embodiment, the card drive 1 in the second embodiment has the following effects even if the card label 3a is of a type that allows only printing operation but does not allow erasing operation. First of all, when a new file is written, the print target area is sequentially updated to print the file name. When a file is deleted, a strike-through is additionally printed on the corresponding file name to indicate that the file has been deleted. Furthermore, a plurality of areas in which remaining storage capacities can be printed are prepared so that every time a new file is written or deleted, printing is performed while the print area is changed, thereby printing the updated contents.

According to the above description, only the remaining storage capacity is printed in the storage capacity print area shown in FIG. 9. However, the stored data capacity may be printed on the card label 3a in the same manner as described above if the print area on the card label 3a is large enough to allow printing.

[4] Printing of New Label:

The card drive 1 in the second embodiment can also create a new card label 3a for the SD card 3 in which files have already been stored. Since this operation is the same as that of the card drive 1 in the first embodiment, a detailed description will be omitted. In creating a new label, the names of stored files may be sequentially printed in print target areas, and only the current remaining storage capacity may be printed in the storage capacity print area.

In this manner, printing on a new label can also be executed independently. That is, for the SD card 3 that has been used in another card drive, label printing can be easily executed on the new card label 3a when it is used in the card drive 1 of this embodiment.

In the first and second embodiments, when the contents stored in the SD card 3 are to be automatically printed, settings are made in advance by operating the operation buttons 16 of the card drive 1 so as to automatically print stored contents. However, an operation state may be set for the card drive 1 under the control of the PC 5.

In the first and second embodiments, the PC 5 executes print control for the card label 3a by referring to the printed contents storage file. However, the card drive 1 may singly control printing on the card label 3a upon reception of access information and write information. Assume that the CPU 10 of the card drive 1 received write or erase access information for the SD card 3. In this case, the CPU 10 checks the name of a file as an access target by referring to the printed content storage file stored in the SD card 3, and performs print control for the card label 3a independently of the PC 5.

With this operation, the PC 5 need not perform special control on the card drive 1, and can execute printing on the card label 3a by performing only general access control on the SD card 3. In addition, since the card drive 1 can execute printing on the card label 3a independently of the PC 5, this card drive can be used in any type of PC 5.

In the first and second embodiments, the printed content storage file is stored in the SD card 3. However, this file may be stored in a RAM 14 in the card drive 1, together with the SD card 3. In this case, the card drive 1 (CPU 10) identifies the SD card 3 connected to the SD card connector 24, reads out the contents of the corresponding printed content storage file from the RAM 14, and executes print control on the card label 3a in the manner described above.

In the first and second embodiments, the card drive 1 is connected to the PC 5 through the USB cable 7 and used as a peripheral device for the PC 5. However, the card drive 1 may be housed in the casing of the PC 5.

In each embodiment described above, an SD card has been described as a card-type medium. However, memory cards having other shapes and functions can also be used. The techniques described in the above embodiments can be written as programs that can be executed by computers in recording media, e.g., magnetic disks (floppy disks, hard disks, and the like), optical disks (CD-ROMs, DVDS, and the like), and semiconductor memories and provided for various apparatuses. These programs can also be transmitted to various apparatuses through communication media. A computer that implements this apparatus loads programs stored in a recording medium or receives programs through a communication medium, and is controlled by the programs, thereby executing the above processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing system for accessing a data storage medium having a card shape, the storage medium having an outer surface on which printing can be performed, comprising:
a data processing section;
a supporting section configured to support the storage medium;
a connecting section configured to interface the data processing section with the storage medium, when the storage medium is supported by the supporting section; and
a printing section configured to perform printing on the outer surface of the storage medium, when the storage medium is supported by the supporting section, the printing section printing, on the outer surface of the storage medium, contents of access to the storage medium which is made by the data processing section to store, delete, or read data with respect to the storage medium through the connecting section.

2. The system according to claim 1, wherein when the data processing section accesses the storage medium to perform data storage or deletion, the printing section prints contents of the data storage or deletion on the outer surface of the storage medium.

3. The system according to claim 1, wherein when the data processing section accesses the storage medium to perform data storage or deletion, the printing section prints contents of a storage capacity after the data storage or deletion on the outer surface of the storage medium.

4. The system according to claim 1, wherein when the data processing section accesses the storage medium to perform a data read, the printing section prints contents of data stored in the storage medium on the outer surface of the storage medium.

5. The system according to claim 1, wherein when the data processing section accesses the storage medium to perform a data read, the printing section prints contents of a storage capacity based on data stored in the storage medium on the outer surface of the storage medium.

6. The system according to claim 1, wherein when the data processing section accesses the storage medium to delete data, the printing section erases contents printed on the outer surface of the storage medium which corresponds to the data.

7. The system according to claim 1, wherein when the data processing section accesses the storage medium to delete data, the printing section prints a mark indicating that data has been erased on contents printed on the outer surface of the storage medium which corresponds to the data.

8. The system according to claim 1, wherein the data processing section causes the storage medium to store a printed content storage file associated with contents printed on the outer surface of the storage medium by the printing section.

9. The system according to claim 1, wherein access to the storage medium which is made by the data processing section and printing by the printing section are performed substantially at the same time.

10. The system according to claim 1, wherein the printing section comprises a thermal head configured to perform printing on the outer surface of the storage medium by using heat.

11. The system according to claim 10, wherein the thermal head erases contents printed on the outer surface of the storage medium by using heat.

12. The system according to claim 1, wherein the supporting section is configured to detachably load the storage medium therein by moving the medium in a first direction, and the printing section comprises a print head movable in a second direction crossing the first direction.

13. The system according to claim 1, wherein the system comprises an information processing apparatus and a peripheral device for information processing configured to communicate with the information processing apparatus, the peripheral device comprising the data processing section, the supporting section, the connecting section, and the printing section.

14. The system according to claim 13, wherein the information processing apparatus comprises a requesting section for requesting the data processing section to access the storage medium and also to cause the printing section to print contents of the access.

15. The system according to claim 13, wherein the peripheral device communicates with the information processing apparatus by cable communication.

16. A peripheral device for information processing configured to communicate with an information processing apparatus and to access a data storage medium having a card shape, the storage medium having an outer surface on which printing can be performed, comprising:
a data processing section;
a supporting section configured to support the storage medium;
a first connecting section configured to interface the data processing section with the information processing apparatus;
a second connecting section configured to interface the data processing section with the storage medium, when the storage medium is supported by the supporting section; and
a printing section configured to perform printing on the outer surface of the storage medium, when the storage medium is supported by the supporting section, the printing section printing, on the outer surface of the storage medium, contents of access to the storage medium which is made by the data processing section to store, delete, or read data with respect to the storage medium through the second connecting section.

17. The device according to claim 16, wherein the peripheral device communicates with the information processing apparatus by cable communication.

18. The device according to claim 16, wherein the data processing section causes the storage medium to store a printed content storage file associated with contents printed on the outer surface of the storage medium by the printing section.

19. The device according to claim 16, wherein access to the storage medium which is made by the data processing section and printing by the printing section are performed substantially at the same time.

20. A peripheral device for information processing configured to communicate with an information processing apparatus and to access a data storage medium having a card shape, the storage medium having an outer surface on which printing can be performed, comprising:
an accessing section configure to access the storage medium; and
a printing section configured to perform printing on the outer surface of the storage medium, wherein the printing section prints, on the outer surface of the storage medium, contents of access to the storage medium which is made by the accessing section to store, delete, or read data with respect to the storage medium.
